(19) United States
(12) Patent Application Publication
(10) Pub. No.: US 2019/0286539 A1
(43) Pub. Date: Sep. 19, 2019

(54) ENTITY RECONCILIATION BASED ON PERFORMANCE METRIC EVALUATION

(71) Applicant: CA, Inc., New York, NY (US)

(72) Inventors: Garry D. Gerossie, JR., Rochester, NH (US); Adam G. Keller, Barrington, NH (US); Jan Gonsalves, Auburn, NH (US)

(21) Appl. No.: 15/922,544

(22) Filed: Mar. 15, 2018

(51) Int. Cl. G06F 11/34; G06F 11/30; H04L 29/12

(52) U.S. Cl. CPC G06F 11/3409; G06F 11/3003; H04L 61/6022; G06F 11/3051; G06F 11/3072

(57) ABSTRACT

A method includes performing, by a processor: monitoring a first entity, where monitoring the first entity includes collecting performance information corresponding to the first entity for one or more performance metrics, monitoring a second entity, where monitoring the second entity includes collecting performance information corresponding to the second entity for the one or more performance metrics, determining difference(s) between the performance information corresponding to the first entity for the one or more performance metrics and the performance information corresponding to the second entity for the one or more performance metrics, comparing the difference(s) with one or more performance thresholds, and determining whether the first entity and the second entity are a same entity based on comparing the difference(s) with the performance threshold(s).

### BACKGROUND

The present disclosure relates to communication systems including computer systems and networking equipment, and, more particularly, to methods, systems, and computer program products for managing computer system and communication network performance.

Computer systems, such as mainframe computer systems, may include performance management software that is designed to detect and diagnose complex software and/or hardware performance problems to maintain an expected level of service. Various types of performance metrics may be monitored: Measurements for these metrics may establish an empirical performance baseline for applications and/or hardware elements, such as servers, processors, databases, networking equipment, and the like. The baseline can then be used to detect changes in performance. Changes in performance may be correlated with external events and subsequently used to predict future changes in system performance. While performance management software may be used to collect diagnostic data on computer system/communication network performance, it may be difficult to identify hardware and/or software elements due to virtualization and service delivery models, such as Software as a Service (SaaS), Infrastructure as a Service (IaaS), Platform as a Service (PaaS), and the like where software and/or hardware resources are typically licensed on a subscription basis and centrally hosted. These types of service delivery models are often referred to generally as cloud services or cloud computing and involve the use of shared pools of configurable resources. Such sharing of resources, however, may make it difficult to distinguish one element from another in a computer system network. For example, FIG. 1A illustrates performance monitoring in a communication network that includes routers 110a, 110b, servers 115a, 115b, and a switch 120 coupled via a communication network 105. A performance monitor 120, which may be a separate server or configured for implementation in whole or in part on one or more of the routers 110a, 110b, servers 115a, 115b, and the switch 120 may be configured to collect performance information for one or more metrics for various ones of the routers 110a, 110b, servers 115a, 115b, and the switch 120. As shown in FIG. 1A, the switch 110a has an Internet Protocol (IP) address of 10.10.22.1 and the switch 110b has an IP address of 10.10.22.2. As a result, the performance data collected for the switches 110a and 110b can be distinguished based on the unique IP addresses assigned to the two switches 110a and 110b. As shown in FIG. 1B, however, routers 110c and 110d have a common IP address of 10.10.22.1. This overlap of IP addresses may be the result of virtualization or other type of resource sharing. Such an overlap, however, may make it difficult to distinguish between the routers 110c and 110d when attributing performance information acquired by the performance monitor 120. Similarly, as shown in FIG. 1C, the performance monitor 120 may be used to collect performance data on a host system including a hypervisor 130 that makes use of an Open Virtual Switch (OVS) 135. In this example, the hypervisor 130, which represents the host hardware, and the OVS 135, which is a software switch, share a common IP address: 10.10.50.5. Thus, it may be difficult to distinguish between a software element, such as the OVS 135, and a hardware element, such as the hypervisor 130 when analyzing performance information acquired by the performance monitor 120.

### SUMMARY

In some embodiments of the inventive subject matter, a method comprises, performing by a processor: monitoring a first entity, where monitoring the first entity comprises collecting performance information corresponding to the first entity for a performance metric, monitoring a second entity, where monitoring the second entity comprises collecting performance information corresponding to the second entity for the performance metric, determining a difference between the performance information corresponding to the first entity for the performance metric and the performance information corresponding to the second entity for the performance metric, comparing the difference with a performance threshold, and determining whether the first entity and the second entity are a same entity based on comparing the difference with the performance threshold.

In other embodiments of the inventive subject matter, a method comprises, performing by a processor: monitoring a first entity, where monitoring the first entity comprises collecting performance information corresponding to the first entity for a first performance metric, monitoring a second entity, where monitoring the second entity comprises collecting performance information corresponding to the second entity for a second performance metric, determining a correlation between the performance information corresponding to the first entity for the first performance metric and the performance information corresponding to the second entity for the second performance metric, and determining that the first entity and the second entity are communicatively coupled based on the correlation.

It is noted that aspects described with respect to one embodiment may be incorporated in different embodiments although not specifically described relative thereto. That is, all embodiments and/or features of any embodiments can be combined in any way and/or combination. Moreover, other methods, systems, articles of manufacture, and/or computer program products according to embodiments of the inventive subject matter will be or become apparent to one with skill in the art upon review of the following drawings and detailed description. It is intended that all such additional systems, methods, articles of manufacture, and/or computer program products be included within this description, be within the scope of the present inventive subject matter, and be protected by the accompanying claims. It is further intended that all embodiments disclosed herein can be implemented separately or combined in any way and/or combination.

### BRIEF DESCRIPTION OF THE DRAWINGS

Other features of embodiments will be more readily understood from the following detailed description of specific embodiments thereof when read in conjunction with the accompanying drawings, in which:

FIGS. 1A-1C are block diagrams that illustrate performance monitoring in communication networks including various computer systems and networking devices;

FIG. 2 is a block diagram of a communication network including a performance management system for reconciling entities based on evaluations of performance metrics in accordance with some embodiments of the inventive concept;

FIG. 3 is a block diagram illustrating virtual machine entities in accordance with some embodiments of the inventive concept;

FIG. 4 illustrates a data processing system that may be sued to implement the performance management system of FIG. 2 in accordance with some embodiments of the inventive concept;

FIG. 5 is a block diagram that illustrates a software/hardware architecture for use in an a performance management system for reconciling entities based on evaluations of performance metrics in accordance with some embodiments of the inventive concept;

FIG. 6 is a flowchart that illustrates operations for reconciling entities based on evaluations of performance metrics in accordance with some embodiments of the inventive concept;

FIG. 7 is a block diagram that illustrates a communication network including an example of reconciling entities based on evaluations of performance metrics in accordance with some embodiments of the inventive concept;

FIG. 8 is a flowchart that illustrates operations for determining a communication coupling between entities based on evaluations of performance metrics in accordance with some embodiments of the inventive concept; and

FIG. 9 is a block diagram that illustrates a communication network including an example of determining a communication coupling between entities based on evaluations of performance metrics in accordance with some embodiments of the inventive concept.

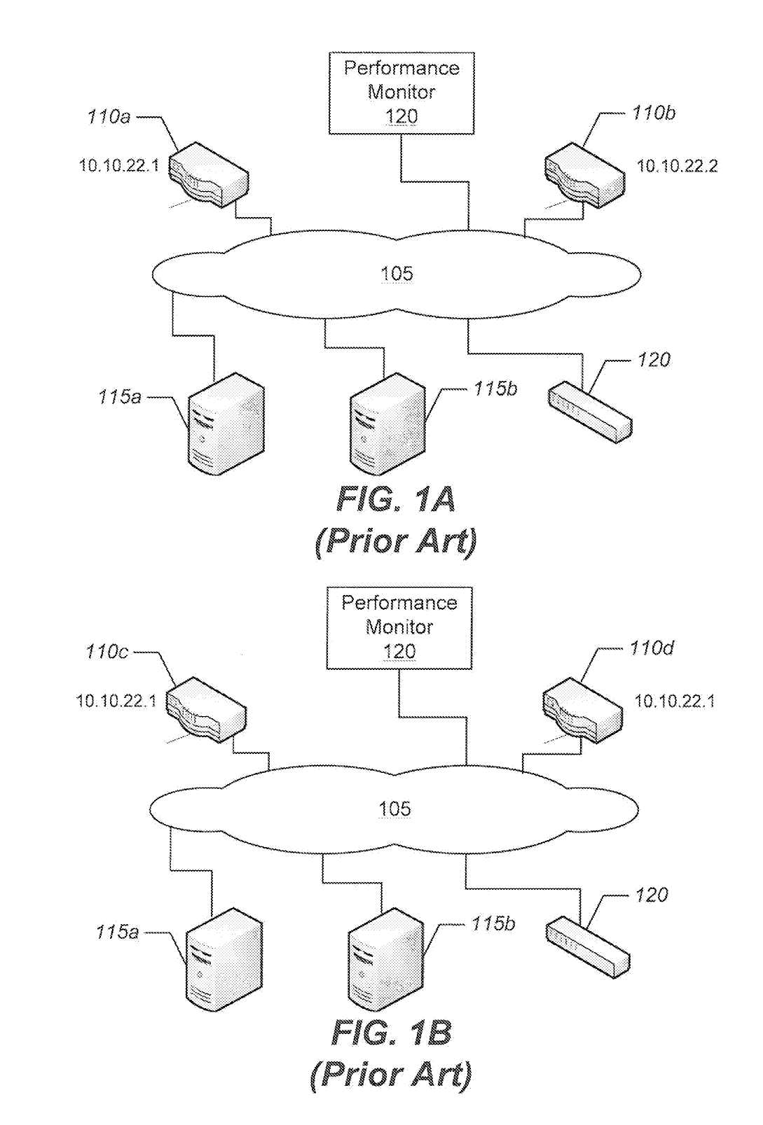

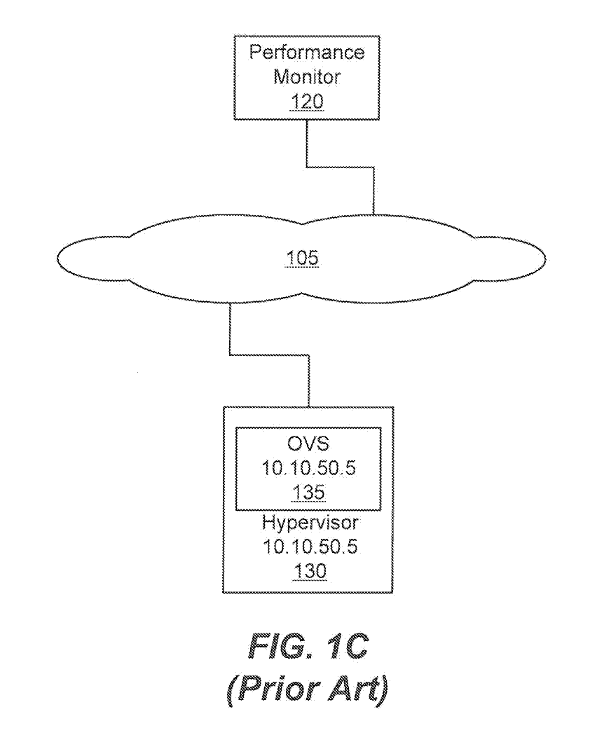

### DETAILED DESCRIPTION

In the following detailed description, numerous specific details are set forth to provide a thorough understanding of embodiments of the present disclosure. However, it will be understood by those skilled in the art that the present invention may be practiced without these specific details. In some instances, well-known methods, procedures, components and circuits have not been described in detail so as not to obscure the present disclosure. It is intended that all embodiments disclosed herein can be implemented separately or combined in any way and/or combination. Aspects described with respect to one embodiment may be incorporated in different embodiments although not specifically described relative thereto. That is, all embodiments and/or features of any embodiments can be combined in any way and/or combination.

As used herein, a “service” includes, but is not limited to, a software and/or hardware service, such as cloud services in which software, platforms, and infrastructure are provided remotely through, for example, the Internet. A service may be provided using Software as a Service (SaaS), Platform as a Service (PaaS), and/or Infrastructure as a Service (IaaS) delivery models. In the SaaS model, customers generally access software residing in the cloud using a thin client, such as a browser, for example. In the PaaS model, the customer typically creates and deploys the software in the cloud sometimes using tools, libraries, and routines provided through the cloud service provider. The cloud service provider may provide the network, servers, storage, and other tools used to host the customer's application(s). In the IaaS model, the cloud service provider provides physical and/or virtual machines along with hypervisor(s). The customer installs operating system images along with application software on the physical and/or virtual infrastructure provided by the cloud service provider.

As used herein, the term “data processing facility” includes, but it is not limited to, a hardware element, firmware component, and/or software component. A data processing system may be configured with one or more data processing facilities.

As used herein the term “entity” may include a hardware element, a software element, and/or an element that has one or more hardware elements and/or software elements in combination.

Some embodiments of the inventive concept stem from a realization that resource sharing and virtualization on which many cloud computing models are based may result in an overlap of IP addresses, MAC addresses, or other identifiers that are used to distinguish hardware and/or software entities from each other. Embodiments of the present inventive concept may provide a mechanism for using performance information for one or more performance metrics to identify various entities as being the same entity based on the different entities exhibiting similar performance characteristics for one or more metrics. In addition to determining whether two or more entities may be same entity, performance information collected for various entities may be evaluated to determine whether the performance profiles of the entities are correlated with each other. A determination that two entities are communicatively coupled may be made based on this correlation providing insight into the topology of a communication system and/or communication network. A system administrator may use the entity reconciliation information and/or the topology information to modify the configuration of one or more entities to improve the performance, reliability, or other characteristic of a computer system and/or communication network.

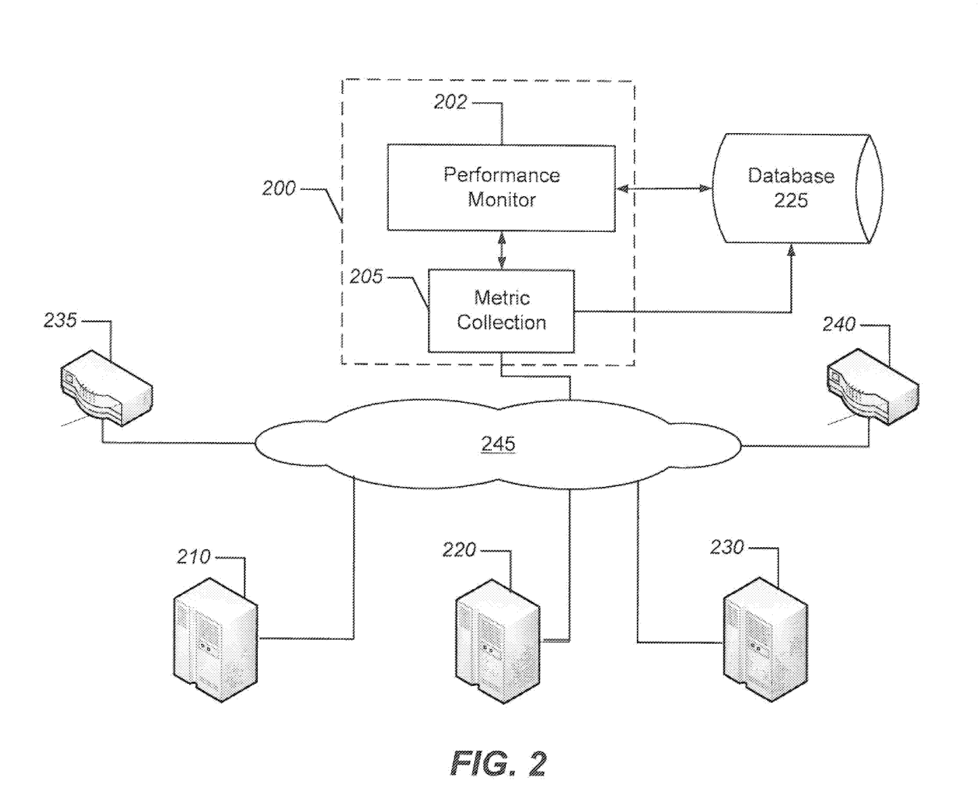

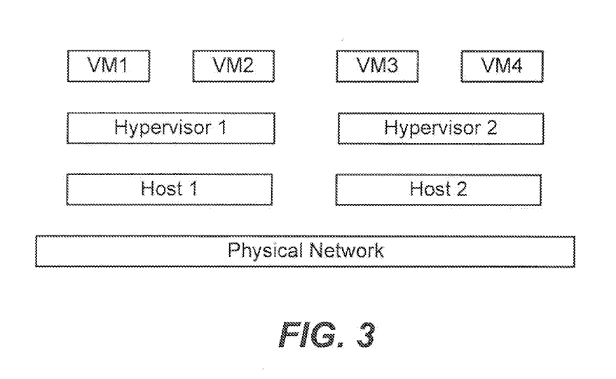

Referring to FIG. 2, a communication network including a performance management system for reconciling entities based on evaluations of performance metrics, in accordance with some embodiments of the inventive concept, comprises a performance management system 200, routers 235, 240, and servers 210, 220, and 230 coupled via a communication network 245. The network 245 may be a global network, such as the Internet or other publicly accessible network. Various elements of the network 245 may be interconnected by a wide area network, a local area network, an Intranet, and/or other private network, which may not be accessible by the general public. Thus, the communication network 245 may represent a combination of public and private networks or a virtual private network (VPN). The network 245 may be a wireless network, a wireline network, or may be a combination of both wireless and wireline networks. One or more of the servers 210, 220, 230 may represent host(s) that support one or more virtual machines. For example, as shown in FIG. 3, servers 110 and 120 may represent Host 1 and Host 2, respectively. Each host supports two virtual machines via a hypervisor. Host 1 supports virtual machines VM1 and VM2 via Hypervisor 1 and Host 2 supports virtual machines VM3 and VM4 via Hypervisor. These virtual machines VM1, VM2, VM3, and VM4 may be viewed as pooled resources that are instantiated and allocated to customers on a subscription or as needed basis by a service provider. The central hosting of shared hardware and/or software resources, such as virtual machines, routers, switches, and delivery to customers on a subscription or on-demand basis is sometimes referred to as cloud computing and/or cloud service delivery. The virtualization of such hardware and/or software entities and sharing between multiple customers may, however, make it difficult to distinguish between entities in the cloud or service delivery network. The performance management system 200, in some embodiments, may include a performance monitor 202 and a metric collection module 205. The performance management monitor 202 and/or the metric collection module 205 may be configured for implementation in Whole or in part on one or more of the routers 235, 240, and servers 210, 220, and 230. The metric collection module 205 is configured to communicate with the routers 235, 240, and the servers 210, 220, and 230 to collect performance information from these entities for various performance metrics and to provide the information to the performance monitor 202 and/or information repository, e.g., database 225, for processing. The performance management system 200 may be configured to distinguish between different entities connected to the network 245 based on an evaluation of the performance information collected for one or more metrics even though the entities may share common identifiers, such as common Internet Protocol (IP) addresses and/or Media Access Control (MAC) addresses. Although two routers 235 and 240 and three servers 210, 220, and 230 are shown, it will be understood that the performance of fewer or more entities, including other types of entities, such as hardware switches, software switches, firewalls, gateways, and the like, can be managed in accordance with various embodiments of the inventive concept. It will be appreciated that in accordance with various embodiments of the inventive concept, the performance management system may be implemented as a single server, separate servers, or a network of servers either co-located in a server farm, for example, or located in different geographic regions.

Although FIG. 2 illustrates an exemplary communication network including a performance management system for reconciling entities based on evaluation of performance metrics, it will be understood that embodiments of the inventive concept are not limited to such configurations, but are intended to encompass any configuration capable of carrying out the operations described herein.

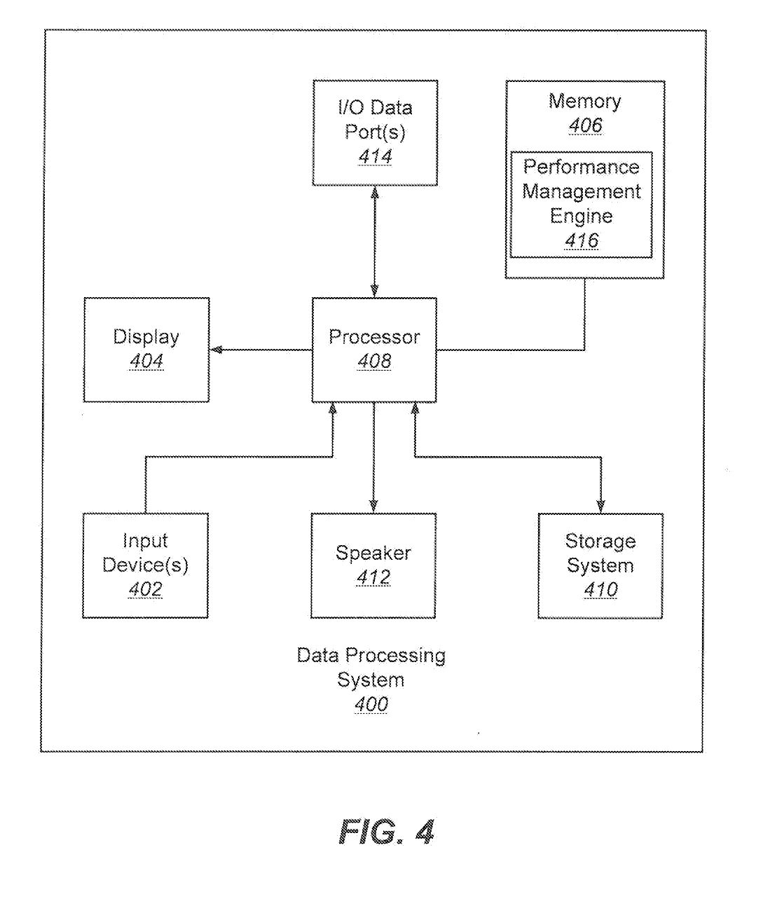

Referring now to FIG. 4, a data processing system 400 that may be used to implement the performance management system 200 of FIG. 2, in accordance with some embodiments of the inventive concept, comprises input device(s) 402, such as a keyboard or keypad, a display 404, and a memory 406 that communicate with a processor 408. The data processing system 400 may further include a storage system 410, a speaker 412, and an input/output (I/O) data port(s) 414 that also communicate with the processor 408. The storage system 410 may include removable and/or fixed media, such as floppy disks, ZIP drives, hard disks, or the like, as well as virtual storage, such as a RAMDISK. The I/O data port(s) 414 may be used to transfer information between the data processing system 400 and another computer system or a network (e.g., the Internet). These components may be conventional components, such as those used in many conventional computing devices, and their functionality, with respect to conventional operations, is generally known to those skilled in the art. The memory 406 may be configured with a performance management engine module 416 that may provide functionality that may include, but is not limited to, reconciling entities based on evaluations of performance metrics in accordance with some embodiments of the inventive concept.

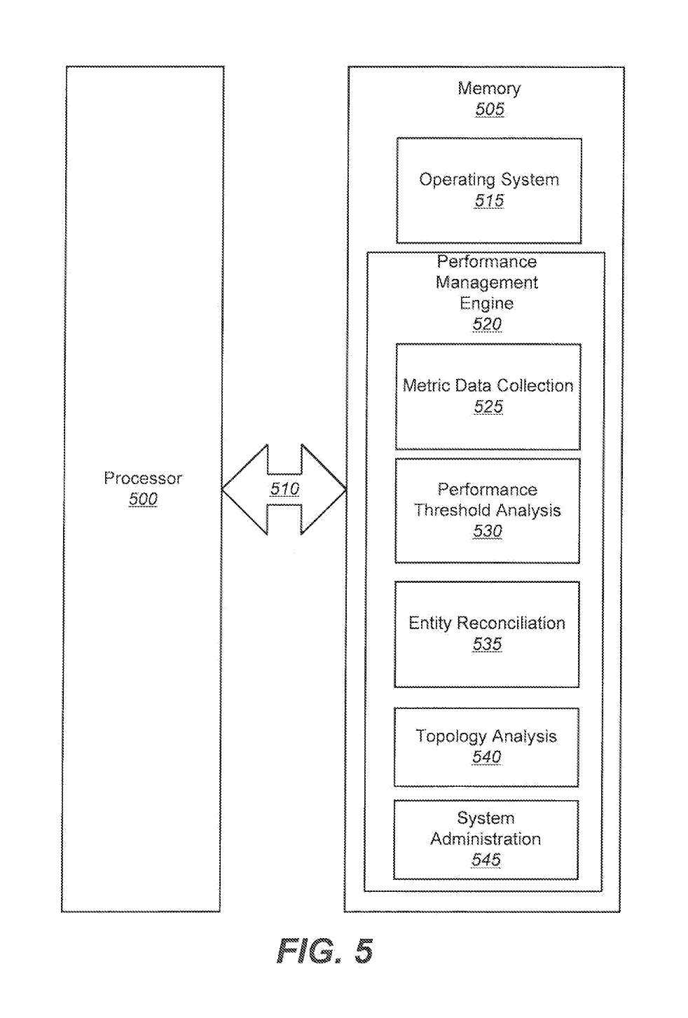

FIG. 5 illustrates a processor 500 and memory 505 that may be used in embodiments of data processing systems, such as the performance management system 200 of FIG. 2 and the data processing system 400 of FIG. 4, respectively, for reconciling entities based on evaluations of performance metrics in accordance with some embodiments of the inventive concept. The processor 500 communicates with the memory 505 via an address/data bus 510. The processor 500 may be, for example, a commercially available or custom microprocessor. The memory 505 is representative of the one or more memory devices containing the software and data used for reconciling entities based on evaluations of performance metrics in accordance with some embodiments of the inventive concept. The memory 505 may include, but is not limited to, the following types of devices: cache, ROM, PROM, EPROM, EEPROM, flash, SRAM, and DRAM.

As shown in FIG. 5, the memory 505 may contain two or more categories of software and/or data: an operating system 515 and a performance management engine module 520. In particular, the operating system 515 may manage the data processing system's software and/or hardware resources and may coordinate execution of programs by the processor 500. The performance management engine module 520 may comprise a metric data collection module 525, a performance threshold analysis module 530, an entity reconciliation module 535, a topology analysis module 540, and a system administration module 545.

The metric data collection module 525 may be configured to communicate with one or more entities in a computer system or communication network to collect performance data for one or more system performance metrics. The performance data may be associated with a variety of different performance metrics that may include, but are not limited to, for example, a count of a number of communication interfaces, an amount of installed memory, a memory utilization, a count of virtual machines running on a hypervisor, a processor utilization, and an interface utilization.

The performance threshold analysis module 530 may be configured to receive the performance information collected by the metric data collection module 525 and compare the performance information collected for the respective metric(s) for the various entities with each other. The performance threshold analysis module 530 may be used to establish thresholds for the various metrics and to use these thresholds in comparing performance information collected for the respective metric(s) for the various entities with each other. For example, for a given metric, the performance threshold analysis module may determine whether the difference between the performance information collected for the given metric for a first entity and a second entity is less than a defined threshold for that metric. Similar operations may be performed for each of the metrics for which performance information is collected and each of the entities in the computer system and/or communication network.

The performance entity reconciliation module 535 may be configured to receive the performance metric threshold comparison information from the performance threshold analysis module and determine whether two or more entities are the same entity or are different entities even if those entities have indistinguishable identifiers, such as the same IP addresses and/or MAC addresses. In some embodiments, a determination may be made whether two entities are the same entity when the difference between the performance information for the entities for a given performance metric is less than the threshold associated with that metric. In other embodiments, the determination may be made so as to include an assigned confidence level that the entities are the same entity based on the difference between the performance information for entities for the metric. In other embodiments, the determination may be made based on a comparison of the differences between performance information for multiple entities collected for a plurality of performance metrics and the plurality of performance thresholds associated with those metrics, respectively. When multiple metrics are considered, a count of the number of metrics for which the differences do not exceed the respective performance thresholds may be a factor in determining whether the entities are indeed the same entity. Similarly, an assigned confidence level that the entities are the same entity may be included based both on the differences between the performance information and the performance thresholds for the various metrics and the number of metrics for which the differences do not exceed the performance thresholds. As some metrics may be more important than other metrics in determining whether two entities are the same entity, a score may be computed based on the differences between the performance information for the various entities for the different metrics where the various differences are weighted differently to reflect the relative importance or relevance between the metrics in determining whether two entities are the same entity or are different entities. In some embodiments, this score may further reflect the count of the number of metrics which the differences do not exceed the respective performance thresholds. A confidence level that the entities are the same entity may be included based on the score.

The topology analysis module 540 may be configured to receive the performance metric threshold comparison information from the performance threshold analysis module and determine whether a correlation exists between one entity's performance information for a first performance metric and another entity's performance information for a second performance metric. The entities may be determined to be communicatively coupled when a correlation exists between the performance information. In accordance with various embodiments, the performance metrics may be the same performance metric or may be different performance metrics. This coupling may be indicative of a topology of the computer system and/or communication network. Such topological information may assist a system administrator, for example, in determining potential bottlenecks, fault points, and/or other vulnerabilities in a computer system and/or communication network.

The system administration module 545 may be configured to modify the configuration of one or more entities identified by the entity reconciliation module 535 and/or topology analysis module 540 to improve the performance, reliability, or other characteristic of a computer system and/or communication network based on a more detailed understanding of the identities of the various entities and/or topological connections between the entities in the computer system and/or communication network.

Although FIG. 5 illustrates hardware/software architectures that may be used in data processing systems, such as the performance management system 200 of FIG. 2 and the data processing system 400 of FIG. 4, respectively, for reconciling entities based on evaluations of performance metrics in accordance with some embodiments of the inventive concept, it will be understood that the present invention is not limited to such a configuration but is intended to encompass any configuration capable of carrying out operations described herein.

Computer program code for carrying out operations of data processing systems discussed above with respect to FIGS. 2-5 may be written in a high-level programming language, such as Python, Java, C, and/or C++, for development convenience. In addition, computer program code for carrying out operations of embodiments of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

Moreover, the functionality the performance management system 200 of FIG. 2, the data processing system 400 of FIG. 4, and the hardware/software architecture of FIG. 5, may each be implemented as a single processor system, a multi-processor system, a multi-core processor system, or even a network of stand-alone computer systems, in accordance with various embodiments of the inventive subject matter. Each of these processor/computer systems may be referred to as a “processor” or “data processing system.”

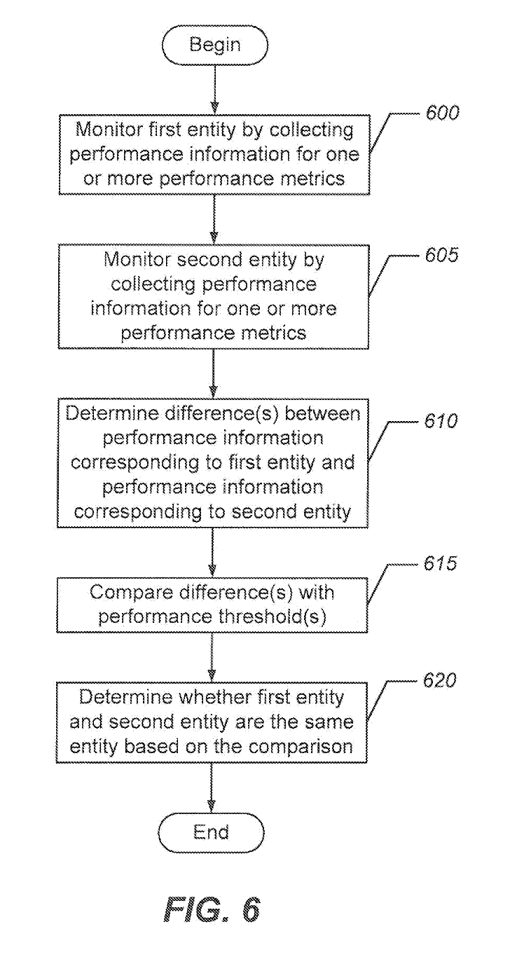

The data processing apparatus of FIGS. 2-5 may be used to facilitate the reconciliation of entities based on evaluations of performance metrics according to various embodiments described herein. These apparatus may be embodied as one or more enterprise, application, personal, pervasive and/or embedded computer systems and/or apparatus that are operable to receive, transmit, process and store data using any suitable combination of software, firmware and/or hardware and that may be standalone or interconnected by any public and/or private, real and/or virtual, wired and/or wireless network including all or a portion of the global communication network known as the Internet, and may include various types of tangible, non-transitory computer readable media. In particular, the memory 406 coupled to the processor 408 and the memory 505 coupled to the processor 500 include computer readable program code that, when executed by the respective processors, causes the respective processors to perform operations including one or more of the operations described and illustrated herein with respect to FIGS. 6-9.

FIG. 6 is a flowchart that illustrates operations for reconciling entities based on evaluations of performance metrics in accordance with some embodiments of the inventive concept. Operations begin at blocks 600 and 605 where the metric data collection module 525 monitors multiple entities, such as a first entity and second entity in a computer system and/or communication network, by collecting performance information for one or more performance metrics. The performance data may be associated with a variety of different performance metrics that may include, but are not limited to, for example, a count of a number of communication interfaces, an amount of installed memory, a memory utilization, a count of virtual machines running on a hypervisor, a processor utilization, and an interface utilization. At block 610, the performance threshold analysis module 530 determines the difference(s) between performance information corresponding to the first entity and the performance information corresponding to the second entity that has been collected by the metric data collection module 525 for the one or more performance metrics. The performance threshold analysis module 530 then compares the differences between the performance information associated with the difference entities with performance thresholds defined for the respective metrics at block 615. The entity reconciliation module 535 determines whether two entities are the same entity based on the comparison of the difference between their performance information for one or more metrics and the performance thresholds defined for those respective metrics at block 620. In some embodiments, the entity reconciliation module 535 may determine whether two entities are the same entity when the difference between the performance information for the entities for a given performance metric is less than the threshold associated with that metric. In further embodiments, the entity reconciliation module 535 may assign a confidence level to the determination based on the difference between the performance information for entities for the metric. In other embodiments, when multiple metrics are evaluated, a count of the number of metrics for which the differences do not exceed the respective thresholds may be a factor in determining whether the entities are the same entity. Similarly, an assigned confidence level that the entities are the same entity may be included based both on the differences between the performance information and the performance thresholds for the various metrics and the number of metrics for which the differences do not exceed the performance thresholds. Some performance metrics may be more useful or indicative of entities being different or the same and, therefore, may be weighted accordingly by the entity reconciliation module 535 when evaluating whether two entities are the same or different. For example, a score may be computed based on the differences between the performance information for the various entities for the difference metrics where the various differences are weighted differently to reflect the relative importance or relevance between the metrics in determining whether two entities are the same entity or are different entities. In some embodiments, this score may further reflect the count of the number of metrics which the differences do not exceed the respective thresholds. A confidence level that the entities are the same entity may be included based on the score.

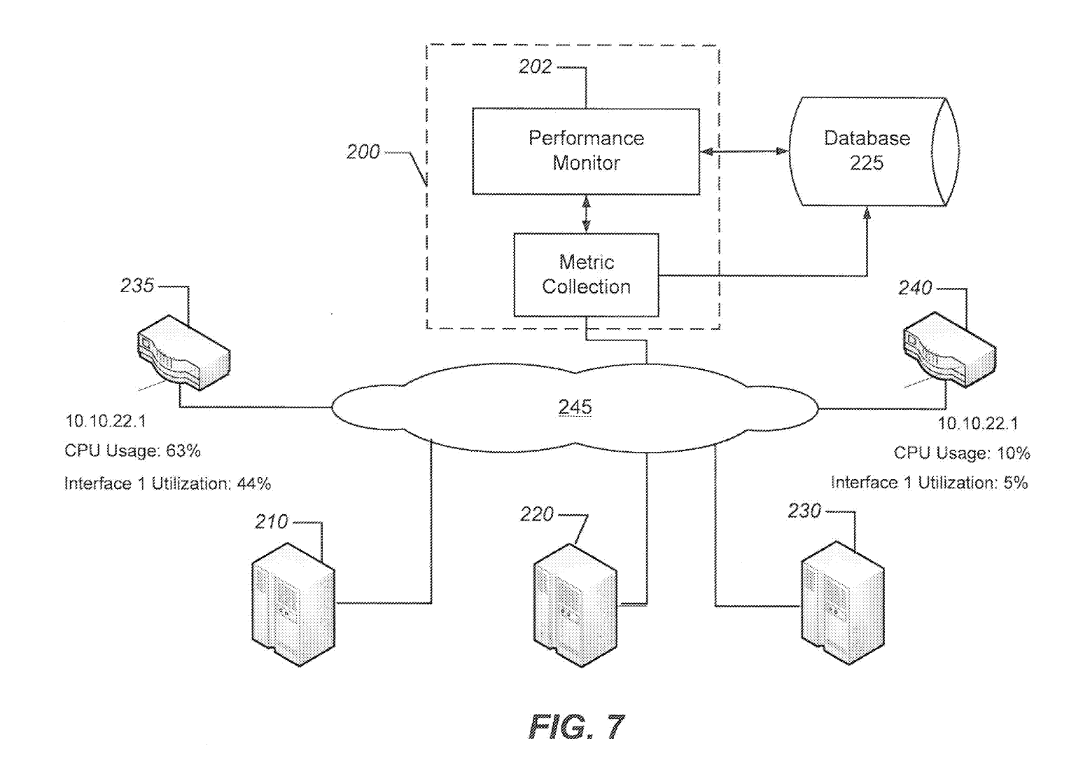

Embodiments of the inventive concept for reconciling entities based on an evaluation of performance metrics may be illustrated by way of example FIG. 7 is a block diagram of the communication network of FIG. 2 in which the routers 235 and 240 have indistinguishable IP addresses 10.10.22.1 associated therewith. As a result, it may be difficult for a system administrator to tell whether these routers 235 and 240 are the same entity or are actually different entities. Performance information has been collected for each of the routers 235 and 240 using the metric data collection module 525 for the metrics CPU usage and Interface 1. Utilization. As shown in FIG. 7, the difference in CPU usage between the two routers 235 and 240 is 53% and the difference in Interface 1. Utilization between the two routers 235 and 240 is 39%. If the performance thresholds for the two metrics CPU Usage and Interface 1. Utilization are 10% and 5%, respectively, then the entity reconciliation module 535 may determine that the difference in performance between the two routers 235 and 240 for both metrics exceeds the defined thresholds that the two routers 235 and 240 are different entities even though they have the same IP address assigned thereto. If, for example, the difference in CPU Usage was 15%, but the difference in Interface 1. Utilization was 2%, then the entity reconciliation module 535 may determine that the two routers 235 and 240 are the same entity with a 85% confidence level as even though the difference in CPU Usage exceeds the 10% threshold, it does not exceed the threshold by a large amount and the Interface 1. Utilization difference is less than the 5% threshold. Moreover, the Interface 1. Utilization may be given more weight than the CPU Usage. A system administrator may modify the configuration of the network 245 and the entities thereon, including the routers 235 and 240, by way of the system administration module 545 to manage the amount of traffic routed by the routers 235 and 240 based on whether they are separate entities or the same entity.

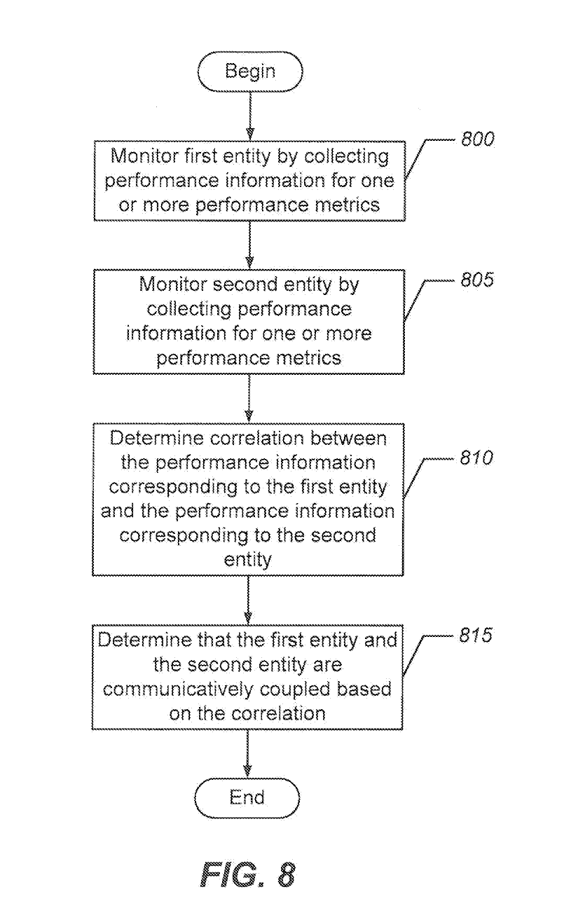

FIG. 8 is a flowchart that illustrates operations for determining a communication coupling between entities based on evaluations of performance metrics in accordance with some embodiments of the inventive concept. Operations begin at blocks 800 and 805 where the metric data collection module 525 monitors multiple entities, such as a first entity and second entity in a computer system and/or communication network, by collecting performance information for one or more performance metrics. The performance data may be associated with a variety of different performance metrics that may include, but are not limited to, for example, a count of a number of communication interfaces, an amount of installed memory, a memory utilization, a count of virtual machines running on a hypervisor, a processor utilization, and an interface utilization. At block 810, the topology analysis module 540 may determine whether a correlation exists between one entity's performance information for a first performance metric and another entity's performance information for a second performance metric. In accordance with various embodiments of the inventive concept, the first and second metrics may be the same performance metric or different performance metrics. The correlation may be based on identifiable changes in performance metric information for one or more metrics for one entity that occur in concert or some identifiable relationship with changes in performance metric information for one or more metrics for another entity. A determination may be made at block 815 that the first and second entities are communicatively coupled based on whether the correlation exists. For example, the entities may be determined to be communicatively coupled when a correlation exists between the performance information. This coupling may be indicative of a topology of the computer system and/or communication network.

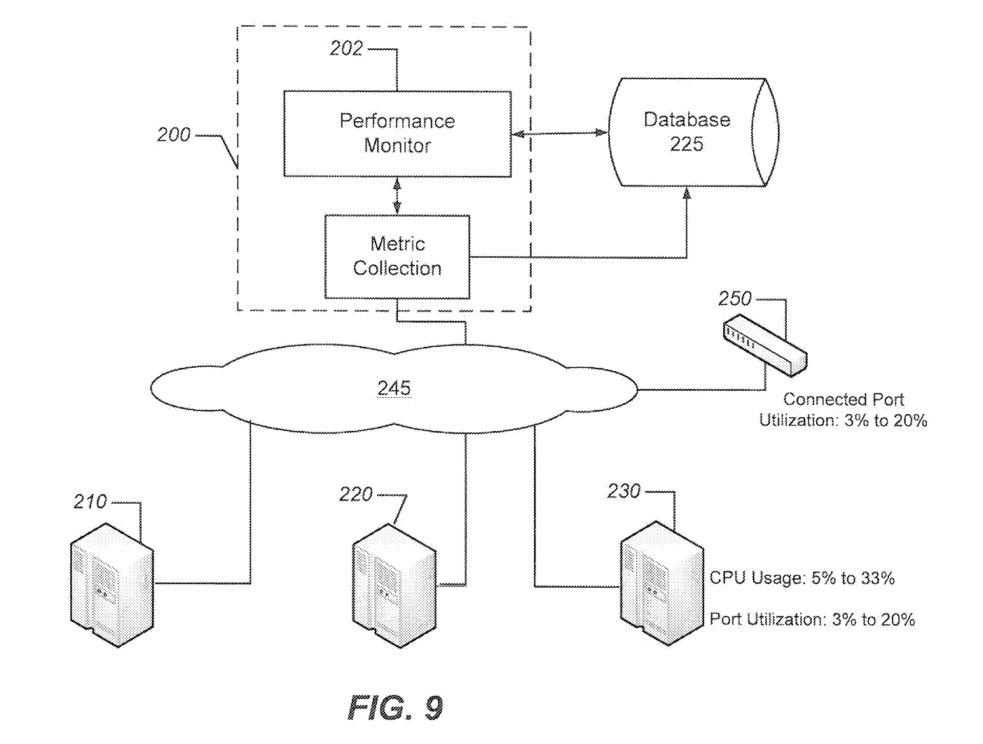

Embodiments of the inventive concept for determining a communication coupling between entities based on an evaluation of performance metrics may be illustrated by way of example. FIG. 9 is a block diagram of the communication network of FIG. 2 in which the routers 235 and 240 have been replaced with a switch 250. As illustrated in FIG. 9, the CPU Usage metric for the server 230 is shown to have increased from 5% to 33% and the Port utilization metric is shown to have increased from 3% to 20%. In concert with this change in performance information for the CPU Usage metric and Port Utilization metric of the server 230, the Port Utilization metric for the switch 250 also increased from 3% to 20%. The temporal alignment of the increase in Port Utilization for the switch 250 with both the increases in both the CPU Usage metric and the Port Utilization metric of the server 230 may indicate a correlation between the operation of the server 230 and the switch 250. This correlation may also be indicative that the server 230 is connected to a port on the switch 250. The system administration module 545 may be configured to modify the configuration of one or more entities on the communication network 245, including the switch 250 and server 230, based on an understanding of the topological connection between the switch 250 and server 230 and/or other connections.

Consumers of computing resources increasingly acquire processing, software, and/or network resources through cloud service providers in which resources are pooled and leased to customers on a subscription or on-demand basis. This resource sharing and virtualization on which many cloud computing models are based may result in an overlap of IP addresses, MAC addresses, or other identifiers that are used to distinguish hardware and/or software entities from each other. Embodiments of the present inventive concept may provide a mechanism for using performance information for one or more performance metrics to identify various entities as being the same entity based on the different entities exhibiting similar performance characteristics for one or more metrics. The determination of whether two entities are the same entity may include a confidence level that is based on the degree to which the two entities exhibit a same profile for one or more performance metrics. In addition to determining whether two or more entities may be same entity, performance information collected for various entities may be evaluated to determine whether the performance profiles of the entities are correlated with each other. A determination that two entities are communicatively coupled may be made based on this correlation providing insight into the topology of a communication system and/or communication network. The correlation may be based on identifiable changes in performance metric information for one or more metrics for one entity that occur in concert or some identifiable relationship with changes in performance metric information for one or more metrics for another entity. A system administrator may use the entity reconciliation information and/or the topology information to modify the configuration of one or more entities to improve the performance, reliability, or other characteristic of a computer system and/or communication network.

### Further Definitions and Embodiments

In the above-description of various embodiments of the present disclosure, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart, and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. A method, comprising:
performing by a processor:
monitoring a first entity, wherein monitoring the first entity comprises collecting performance information corresponding to the first entity for a performance metric;
monitoring a second entity, wherein monitoring the second entity comprises collecting performance information corresponding to the second entity for the performance metric;
determining a difference between the performance information corresponding to the first entity for the performance metric and the performance information corresponding to the second entity for the performance metric;
comparing the difference with a performance threshold; and
determining whether the first entity and the second entity are a same entity based on comparing the difference with the performance threshold.

2. The method of claim 1, wherein determining whether the first entity and the second entity are the same entity comprises:
determining that the first entity and the second entity are the same entity when the difference does not exceed the performance threshold.

3. The method of claim 1, wherein determining whether the first entity and the second entity are the same entity comprises:
determining that the first entity and the second entity are not the same entity when the difference exceeds the performance threshold.

4. The method of claim 1, wherein determining whether the first entity and the second entity are the same entity comprises:
assigning a confidence level that the first entity and the second entity are the same entity based on comparing the difference with the performance threshold.

5. The method of claim 1, wherein the method further comprises:
modifying a configuration of one of the first entity and the second entity based on determining whether the first entity and the second entity are the same entity.

6. The method of claim 1, wherein monitoring the first entity comprises collecting performance information corresponding to the first entity for a plurality of performance metrics;
wherein monitoring the second entity comprises collecting performance information corresponding to the second entity for the plurality of performance metrics;
wherein determining the difference between the performance information corresponding to the first and the performance information corresponding to the second entity comprises determining a plurality of differences between the performance information corresponding to the first entity for the plurality of performance metrics and the performance information corresponding to the second entity for the plurality of performance metrics;
wherein comparing the difference with the performance threshold comprises comparing the plurality of differences with a plurality of performance thresholds, respectively; and
wherein determining whether the first entity and the second entity are the same entity comprises determining whether the first entity and the second entity are the same entity based on comparing the plurality of differences with the plurality of performance thresholds.

7. The method of claim 6, wherein determining whether the first entity and the second entity are the same entity comprises:
determining that the first entity and the second entity are the same entity when a count of ones of the plurality of differences that do not exceed the plurality of performance thresholds, respectively, exceeds a count threshold.

8. The method of claim 6, wherein determining whether the first entity and the second entity are the same entity comprises:
determining that the first entity and the second entity are not the same entity when a count of ones of the plurality of differences that do not exceed the plurality of performance thresholds, respectively, does not exceed a count threshold.

9. The method of claim 6, wherein the method further comprises:
assigning a plurality of weights to the plurality of differences, respectively; and
computing a score based on the plurality of weights and comparing the plurality of differences with the plurality of performance thresholds.

10. The method of claim 9, wherein computing the score further comprises:
computing the score based on a count of ones of the plurality of differences that do not exceed the plurality of performance thresholds, respectively.

11. The method of claim 6, wherein determining whether the first entity and the second entity are the same entity comprises:
assigning a confidence level that the first entity and the second entity are the same entity based on comparing the difference with the performance threshold.

12. The method of claim 1, wherein the performance metric comprises one of a count of a number of communication interfaces, an amount of installed memory, a memory utilization, a count of virtual machines running on a hypervisor, a processor utilization, and an interface utilization.

13. The method of claim 1, wherein the first entity has a corresponding first identifier and the second entity has a corresponding second identifier; and
wherein the first identifier is indistinguishable from the second identifier.

14. The method of claim 13, wherein the first identifier and the second identifier are Internet Protocol (IP) addresses, respectively.

15. The method of claim 13, wherein the first identifier and the second identifier are Media Access Control (MAC) addresses, respectively.

16. A method, comprising:
performing by a processor:
monitoring a first entity, wherein monitoring the first entity comprises collecting performance information corresponding to the first entity for a first performance metric;
monitoring a second entity, wherein monitoring the second entity comprises collecting performance information corresponding to the second entity for a second performance metric;
determining a correlation between the performance information corresponding to the first entity for the first performance metric and the performance information corresponding to the second entity for the second performance metric; and
determining that the first entity and the second entity are communicatively coupled based on the correlation.

17. The method of claim 16, wherein the method further comprises:
modifying a configuration of one of the first entity and the second entity based on determining that the first entity and the second entity are communicatively coupled.

18. The method of claim 16, wherein the first performance metric and the second performance metric are different performance metrics.

19. The method of claim 16, wherein the first performance metric and the second performance metric are a same performance metric.

20. The method of claim 16, wherein each of the first performance metric and the second performance metric comprises one of a count of a number of communication interfaces, an amount of installed memory, a memory utilization, a count of virtual machines running on a hypervisor, a processor utilization, and an interface utilization.
